(19) United States
(12) Patent Application Publication
(10) Pub. No.: US 2025/0217496 A1
(43) Pub. Date: Jul. 3, 2025

(54) METHOD AND MODULE FOR DETECTING ATTEMPTED CYBER ATTACKS IN A FLEET OF COMPUTERS

(71) Applicant: Orange, Issy-les-Moulineaux (FR)

(72) Inventors: Maxime Belair, Chatillon (FR); Sylvie Laniepce, Chatillon (FR); Adam Ouorou, Chatillon (FR)

(21) Appl. No.: 18/841,958

(22) PCT Filed: Feb. 16, 2023
(86) PCT No.: PCT/EP2023/053824

§ 371 Date: Aug. 27, 2024

(30) Foreign Application Priority Data
Feb. 28, 2022 (FR) FR2201751

(51) Int. Cl. G06F 21/57; G06F 21/54

(52) U.S. Cl. CPC G06F 21/577; G06F 21/54

(57) ABSTRACT

A method for detecting an attempted cyber attack is described, the method being implemented by a computer, the attack exploiting a vulnerability in a function to be protected running in a process of a user space of said computer, where launching of the execution of the function to be protected results in the execution, before the attack, of a function of the kernel. The method includes executing a mitigation policy in the kernel, the mitigation policy being associated with the function of the kernel and being loaded into a namespace of the kernel associated with the process and dedicated to security, and sending, to a security management server, a message comprising a datum representative of the process.

### PRIOR ART

The invention relates to the general field of securing computer programs.

The invention more particularly aims a method for orchestrating the computer security of a computer equipment infrastructure using mitigation policies.

It is recalled that when software has a vulnerability, the mitigation does not aim to correct this software which continues to execute normally, but to block the effects of the vulnerability. For example, if software has a security flaw when it sends a particular packet via a packet sending function, mitigation of this vulnerability can consist in blocking the process of sending this particular packet. The mitigation does not remove the vulnerability but it makes it unexploitable.

In the field of computer security, security flaws are listed in a public list accessible at the address https://cve.mitre.org/, each vulnerability referenced in the list being identified by a unique CVE (Common Vulnerabilities and Exposures) identifier.

Thousands of CVE identifiers are issued each year, and complex software can accumulate hundreds of CVEs.

The management of CVEs to maintain the security of a fleet of computer equipment can therefore be excessively complex.

### DISCLOSURE OF THE INVENTION

The invention aims to facilitate the management of the security of a fleet of computers by detecting the processes of these computers undergoing an attempted computer attack. Consequently, the invention makes it possible to strengthen the security of a fleet of computers.

To this end, and according to a first aspect, the invention relates to a method for detecting an attempted computer attack implemented by a computer, said attack exploiting a vulnerability of a function to be protected executing in a process of a user space of said computer, a launching of the execution of the function to be protected resulting in the execution, before said attack, of a function of the kernel, said method including steps of:
executing a mitigation policy in the kernel, the mitigation policy being associated with said kernel function and being loaded into a kernel namespace associated with said process and dedicated to security;
and if said mitigation policy detects during its execution an attack vector supported by said policy and targeting said function to be protected:
sending to a security management server a message including a data representative of said process.

Correlatively, the invention proposes a module for detecting an attempted computer attack in a computer, said attack exploiting a vulnerability of a function to be protected executing in a process of a user space of said computer, a launching of the execution of said function to be protected resulting in the execution, before said attack, of a kernel function, said module including:
an execution submodule configured to execute a mitigation policy in said kernel, said mitigation policy being associated with said kernel function and being loaded into a namespace of the kernel associated with said process and dedicated to security;
a sending submodule configured to send, to a security management server, a message including a data representative of the process, said sending submodule being configured to send said message if said mitigation policy detects an attack vector supported by said policy and targeting said function to be protected.

Thus, the method makes it possible to identify the processes on which computer attacks take place, a computer attack designating one or several instructions making it possible to circumvent one or several security rules in the execution of a computer process.

A flaw in a process is called vulnerability, this flaw making it possible, if exploited, to override security rules of the computer system on which this process is executed. For example, the CVE-2021-44228 vulnerability called “Log4Shell” is present in the logging software component Log4J. The component Log4J is used by many applications using the Java language. This vulnerability allows a remote attacker in the most severe cases to execute an arbitrary code by the target machine.

It is recalled that a namespace isolates, in an abstraction, the instance of a system resource for the processes associated with this namespace. Changes to the system resource are visible to the other processes associated with the namespace, but are invisible to the other processes. The namespaces are in particular used to implement containers. It will be subsequently written that a system resource in a namespace is declared by this namespace.

A container is an execution environment on which processes execute, a container being associated with a set of namespaces making it possible to isolate the execution of these processes from the rest of the processes of the system.

In one embodiment, the data representative of a process and comprised in the message is a data representative of the namespace associated with the process. The detection process then makes it possible to identify the namespaces, for example of the containers, undergoing a computer attack.

It should be specified that the containers constitute only one non-limiting example in one particular embodiment of the method as described above.

The method makes it possible to send messages identifying the namespaces of the attacked processes to a security management server.

The security management server can in particular receive such messages from other computers which implement this same detection method.

Also, in embodiments of the method, the messages sent to a security management server comprise the identifiers of the vulnerabilities exploited by the attacks.

The method presented proposes to use a mitigation policy executed in the computer kernel. Advantageously, it is not necessary to restart the kernel for the mitigation policy to be effective.

According to the method, the program of the mitigation policy loaded into the kernel is an executable program. It is not a simple signature or a simple set of rules.

The execution of the mitigation policy at the kernel level is triggered directly or indirectly by the launching of the execution, in the user space, of the function to be protected.

For example, the execution of the mitigation policy is triggered directly by the function to be protected, in other words by the function to be protected itself.

In another example, the execution of the mitigation policy is triggered indirectly by the function to be protected, in other words by another function of the user space whose execution is triggered by the launching of the execution of the function to be protected.

In one embodiment, the execution of the mitigation policy makes it possible to both detect an attack using this function, and block this attack.

Subsequently, it will be written that the process is attacked, or that the container (or more generally the namespace) in which this process executes is attacked, if an attack is triggered directly or indirectly by the execution of this function.

The method described advantageously makes it possible to report the information on attacked processes to a security management server. This information can for example identify the containers, or more generally the namespaces, in which these processes are executed. The security management server can be controlled by a central administrator.

This method can advantageously be applied to a plurality of computers in a computer fleet, which makes it possible to report to the security management server the information on the attacks undergone by each of the computers in the computer fleet.

In this case, the central administrator has a role of orchestration of the security on the fleet of computers.

The invention also allows the central administrator to avoid the need to manually consult each administrator of each computer so that each of them, for example, manually and locally verifies whether a given vulnerability affects the software of their machine.

According to one particular mode of implementation of the detection method, said mitigation policy is loaded into a namespace dedicated to security and associated with the root process of said computer.

A computer implementing the detection method comprises a root process associated with namespaces inherited by the namespaces of the computer containers. If a mitigation policy is declared in the namespace associated with the root process and dedicated to security, then the namespaces associated with each container and dedicated to security inherit from this mitigation policy. In other words, a process executing in a container will be protected by the mitigation policy declared in the namespace associated with the root process.

This embodiment advantageously makes it possible to automatically monitor all the containers of the computer because each container inherits from the mitigation policies of the namespace associated with the root process of the computer.

Thus, for any container (or more generally for any namespace dedicated to security) of the computer, if a process of this container calls the function to be protected, the mitigation policy is executed and makes it possible to detect whether an attack is in progress in this container.

According to one particular mode of implementation of the invention, the detection method includes steps of:
receiving, from said security management server, a mitigation policy identifier;
installing, in said kernel of the computer, the mitigation policy corresponding to said mitigation policy identifier.

This embodiment advantageously allows a central administrator controlling the security management server to orchestrate the installation of mitigation policies in a fleet of computers.

The mitigation policies can therefore be managed centrally, without requiring the contribution of the administrators of at least some computers of the fleet, which makes it possible to avoid the manual installation of the mitigation policy on at least some, for example on all the machines of the fleet.

According to one particular mode of implementation of the detection method, said installation method includes substeps of:
sending a request including the mitigation policy identifier to a security server;
obtaining, in response to the request, a file describing said mitigation policy;
obtaining an object code of the mitigation policy identified in said description file;
generating an executable code of said mitigation policy from said object code; and
installing the executable code in said kernel.

Advantageously, the detection method proposes to download the program of the appropriate mitigation policy when a vulnerability affecting software executing on the computer equipment has been identified, and to automatically install this program in the kernel of the equipment to mitigate this vulnerability.

As a variant, it can be chosen to systematically install a mitigation policy on all computers. The coupling with a vulnerability scanner proposed here to install the policy only if this scanner detects that the software is potentially vulnerable (independently of its actual exploitability) is an option.

This embodiment thus proposes to install the mitigation policy if necessary from a security server.

This use of a security server makes it possible to advantageously save memory space on the kernel of the computer.

This embodiment also makes it possible to make available to the computer a database including a plurality of mitigation policies that can be installed if necessary, upon decision of the security management server.

According to one particular mode of implementation of the detection method, said step of sending said message to the security management server is implemented from the user space in response to the kernel sending a signal to the user space in order to notify the detection of the attack vector by the mitigation policy.

A signal is sent from the kernel to the user space. This sending is triggered by the execution of the mitigation policy. Particularly, the sending of the message can be coded in the mitigation policy itself. Part of the data to be sent can be coded in the mitigation policy and another part can be retrieved automatically from the kernel (for example the identifier of the namespace dedicated to security and/or the identifier of the current process).

This signal contains the information on the process, for example on the namespace associated with the process and possibly the container of this process, and can identify the attack.

The message sent to the security management server makes it possible to characterize the attacked process and/or its namespace and/or the container in which the process was executed. Particularly, this message can reuse the information contained in the signal transmitted to the user space by the kernel, and can in particular contain additional information to characterize more accurately the attacked container, for example: name of the container image, name of the main process, start time of the container.

Such complementary information can be useful in particular if a container is stopped and relaunched. In this case, a signal obtained by the kernel does not allow making the link between the stopped container and the relaunched container since the latter is associated with a namespace whose identifier has changed with the relaunching of the container. The name of the container image in particular allows making this link. The complementary information can also be useful to be able to apply security processing to all the processes executing a container image identical to that of the attacked process that triggered the execution of the mitigation policy and the sending of the signal.

According to one mode of implementation of the detection method, said at least one message includes at least one piece of information among:
an identifier of the computer;
a data representative of the namespace associated with the attacked process and dedicated to security;
an identifier of the vulnerability;
a time at which the execution of the mitigation policy has been triggered.

This mode of implementation advantageously makes it possible to spatially and temporally locate an attack on a fleet of computers implementing the detection method.

The identifier of the computer is for example its IP (Internet Protocol) address.

The data representative of the container can for example be the identifier of the container namespace dedicated to security and comprising the mitigation policy.

According to a second aspect, the invention proposes an identification method implemented by a security management server to identify an attempted computer attack on at least one computer, said attack exploiting a vulnerability of a function to be protected executing in a user space of the computer. This method includes steps of:
receiving from said at least one computer a message including a data representative of a process executing in said user space, when an attack vector targeting said function to be protected has been detected by the execution, in the kernel of the computer, of a mitigation policy loaded into a kernel namespace dedicated to security and associated with this process;
adding to a list a data representative of this message.

Correlatively, the invention proposes an identification module that can be implemented in a security management server, said module being configured to identify an attempted computer attack on at least one computer, said attack exploiting a vulnerability of a function to be protected executing in a user space of the computer, said module including:
a receiving submodule configured to receive from said at least one computer a message including a data representative of a process executing in said user space, when an attack vector targeting the function to be protected has been detected, in the kernel of the computer, by the execution of a mitigation policy loaded into a kernel namespace dedicated to security and associated with this process;
an adding submodule configured to add to a list a data representative of said message.

The invention proposes a method for identifying, from a server, all the processes attacked in a fleet of computers, and/or the namespaces or containers associated with these processes.

This identification of the attacked processes advantageously makes it possible to facilitate the orchestration of security on the fleet of computers by a central administrator controlling the security management server.

To this end, the invention proposes to pool the messages coming from the attacked computers by adding them to a list.

This list in particular allows the administrator to make decisions regarding the management of security in the fleet of computers. For example, the presence of some attacks on particular processes or containers may encourage installing additional security programs to improve the security of these processes or these containers.

According to one particular mode of implementation, the method includes a step of sending to at least one computer an identifier of said mitigation policy.

Thus, if the central administrator becomes aware of a new vulnerability endangering the fleet of computers, the invention advantageously allows him to order the installation of a mitigation policy on the entire fleet to protect the computers of this vulnerability.

This embodiment makes it possible to avoid urging the administrators of the different computers to manually install the mitigation policies in order to protect these computers.

According to one particular mode of implementation of the invention, the identification method includes a step of sending to said at least one computer, an identifier of a security server from which said mitigation policy is extracted.

In a case where the mitigation policies are distributed across several security servers, the invention allows each computer to identify the security server from which the desired mitigation policy is downloaded.

Each of the methods described above can be implemented by a computer program.

Consequently, the invention also relates to a computer program on a recording medium, this program being capable of being implemented in computer equipment or more generally in a computer. This program includes instructions allowing the implementation of a method as described above.

This program can use any programming language, and be in the form of source code, object code, or intermediate code between source code and object code, such as in a partially compiled form or in any other desirable form.

The invention also relates to an information medium or a recording medium readable by a computer, and including instructions of a computer program as mentioned above.

The information or recording medium can be any entity or device capable of storing the programs. For example, the media can include a storage means such as a ROM for example a CD ROM or a microelectronic circuit ROM, or even a magnetic recording means for example a hard disk or a flash memory.

On the other hand, the information or recording medium can be a transmissible medium such as an electrical or optical signal, which can be conveyed via an electrical or optical cable, by radio link, by wireless optical link or by other means.

The program according to the invention can particularly be downloaded onto an Internet type network.

Alternatively, the information or recording medium can be an integrated circuit in which a program is incorporated, the circuit being adapted to execute or to be used in the execution of one of the methods as described above.

### Brief Description of the Annexes and the Figures

Other characteristics and advantages of the present invention will emerge from the description given below, with reference to the appended drawings which illustrate one exemplary embodiment without any limitation.

On the annexes:
[Annex. 1] The Annex 1 represents a first executable code snippet of a mitigation policy that can be used in one particular embodiment;
[Annex. 2] The Annex 2 represents a second executable code snippet of a mitigation policy that can be used in one particular embodiment;
In the figures:

FIG. 1 represents one implementation of the detection and identification methods in accordance with one particular embodiment;

FIG. 2 represents detection and identification devices in accordance with one particular embodiment;

FIG. 3 represents a step of installing the detection method in accordance with one particular embodiment;

FIG. 4 represents one example of a description file in accordance with one particular mode of implementation;

FIG. 5 represents components of a computer kernel in accordance with one particular embodiment;

FIG. 6 represents a table of the processes stored in a computer kernel in accordance with one particular embodiment;

FIG. 7 represents in flowchart form the main steps of a security method that can be implemented in one particular embodiment.

### DETAILED DESCRIPTION OF SEVERAL PARTICULAR EMBODIMENTS

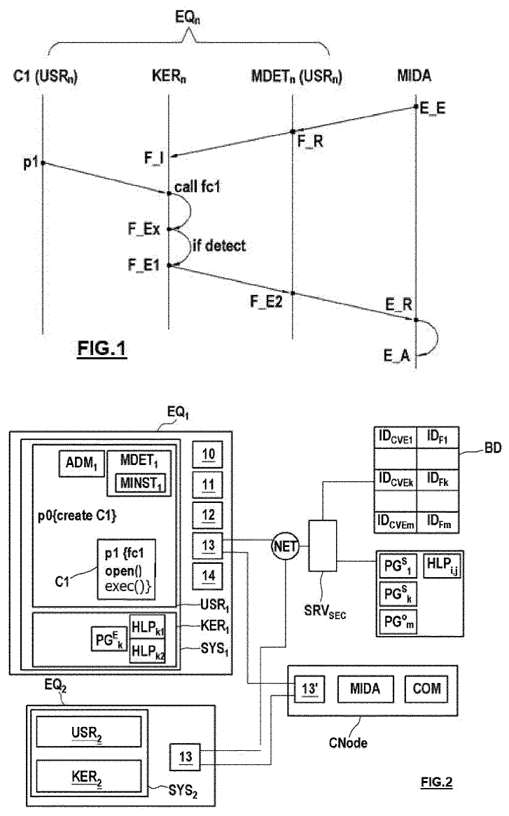

FIG. 1 represents one particular embodiment of the invention in which the detection and identification methods are implemented.

In the example represented in FIG. 1, a single computer EQₙ implements the detection method and the identification method is implemented to identify computer attacks on this computer EQₙ.

Such an example on a single computer is represented for the sake of simplicity but is in no way limiting the invention. Particularly, the detection and identification methods can be implemented on several computers.

It should be specified that in other embodiments of the invention, the detection and identification methods can be implemented independently of each other.

The steps, represented in FIG. 1, of the detection method implemented by the computer EQₙ are steps of:
receiving F_R, from a module MIDA of a security management server, an identifier of a mitigation policy PGₖ;
installing F_I the mitigation policy PGₖ in a kernel KERₙ of the computer EQₙ;
executing F_Ex a mitigation policy PGₖ in the kernel KERₙ;
sending F_E1 a signal from the kernel KERₙ to the user space USRₙ;
sending F_E2, in reaction to said sending F_E1, a message Logᵢ from the user space USRₙ to said security management server CNode.

The steps of the identification method represented in FIG. 1 are steps of:
sending E_E from the security management server to the computer EQₙ, a signal allowing the installation of the mitigation policy PGₖ;
receiving E_R the message Logᵢ coming from the user space USRₙ of the computer EQₙ;
adding E_A a data representative of the message Logᵢ to a list.

The steps of the identification method are carried out by a module MIDA of the security management server CNode while the steps of the detection method are carried out by a module MDETₙ of the user space of the computer EQₙ.

The module MIDA sends and receives signals or messages via communications means 13′ represented in FIG. 2.

The module MDETₙ sends and receives signals or messages via communications means 13.

The signal sent to the computer during step E_E is for example of the form http://IPHost:port/add_policy?namespace=0&CVE_ID=CVEID where “IPHost: port” is the IP address of the computer EQₙ, where the argument “namespace=0” indicates that the mitigation policy is to be installed in a namespace of the root process of the computer EQₙ, and where the argument “CVE_ID=CVEID” indicates the identifier CVEID of the vulnerability CVE against which the containers of the computer EQₙ are protected.

It should be noted that the installation, in this example, of the mitigation policy PGₖ in a namespace of the root process corresponds to one particular mode of implementation of the invention and is not limiting. In particular, namespaces associated with other processes can be chosen to install the mitigation policy PGₖ. Thus, as indication, the signal sent by the security management server and received by the computer may include an argument indicating the namespace in which the mitigation policy PGₖ must be installed, for example a namespace of the root process or another namespace. Also as indication, the server can send to several computers signals indicating that the mitigation policy is to be installed in namespaces that may differ depending on the computers.

The advantage of choosing the namespace of the root process lies in the fact that the containers in which the other processes are executed inherit from the mitigation policy PGₖ installed in the namespace of the root process. Thus, in this case, the mitigation policy makes it possible to detect attempted attacks in all the containers of the computer EQₙ and to protect them.

Following receipt F_R of the signal from the security management server CNode, the module MDETₙ implements an installation step F_I of the mitigation policy PGₖ on the kernel KERₙ, in response to this signal. For example, if this signal contains the identifier of a vulnerability CVE, the module MDETₙ implements the installation of a mitigation policy making it possible to protect the computer EQₙ against this vulnerability.

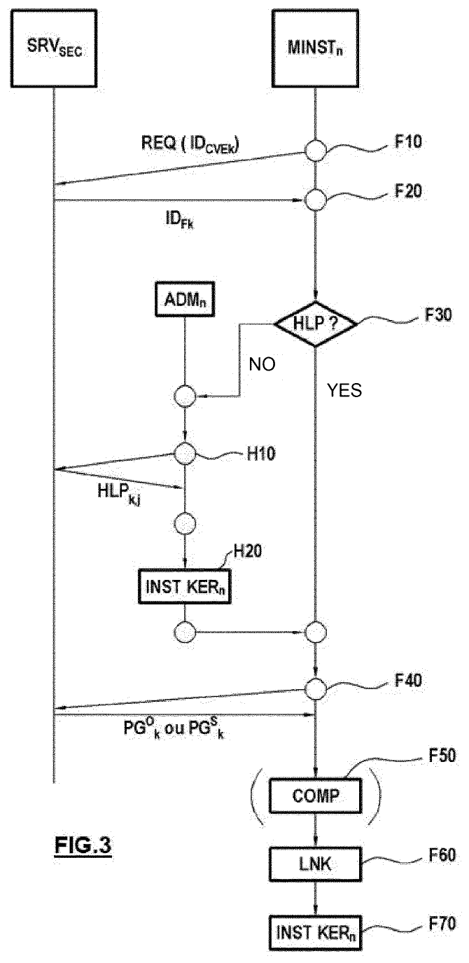

One particular mode of implementation of the installation step F_I is represented in FIG. 3 and will be described below.

FIG. 1 also represents a step of executing F_Ex the mitigation policy PGₖ in the kernel KERₙ. In this example, the execution of the mitigation policy is triggered by the execution (call) of a vulnerable function fc1 called during the execution of the process p1 in the container C1.

In this embodiment, the launching of the execution of this vulnerable function fc1 indirectly leads to the execution of a kernel function oper_exec( ) which itself leads to the execution of the mitigation policy PGₖ. Particularly, the execution of the function to be protected fc1 leads to the execution of a function exec( ) in the user space USRₙ, which itself leads to the execution, in the kernel, of the function oper_exec( ).

In another embodiment, the execution of a function to be protected directly leads to the execution of a function in the kernel associated with a mitigation policy.

The triggering of the mitigation policy PGₖ by the execution of the kernel function oper_exec( ) is for example enabled by a trigger point (hook) well known to those skilled in the art. This mechanism makes it possible to link the mitigation policy PGₖ to the function oper_exec( ) in such a way that the mitigation policy PGₖ is executed before the attack, if it were to occur. Depending on the result of the execution of the mitigation policy, the vulnerable function is blocked or executed.

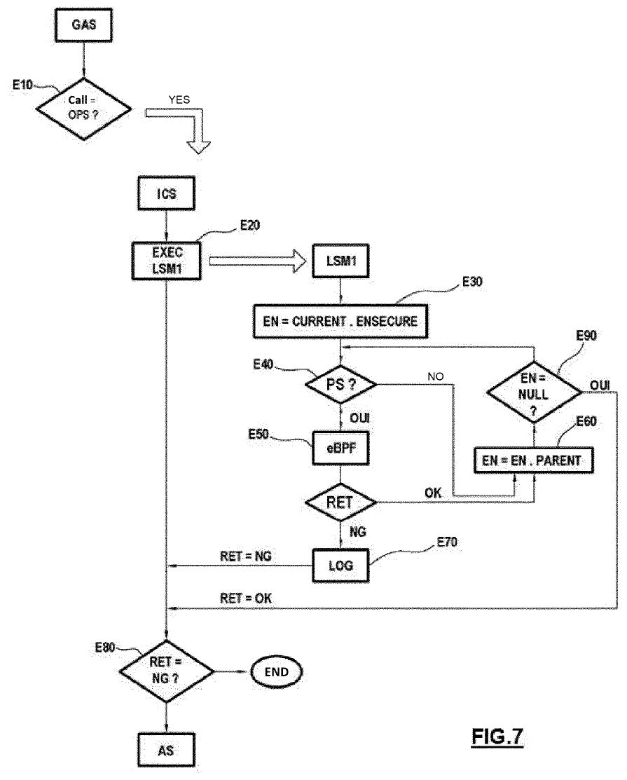

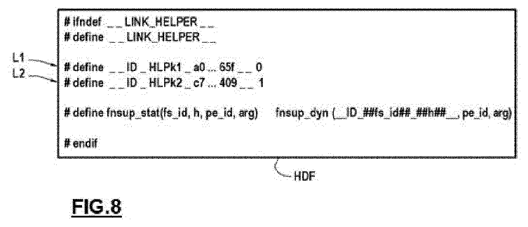

Such execution of the mitigation policy PGₖ in the kernel KERₙ is described in particular in document [1] which proposes a security method using a security policy, the mitigation policy taking the role of a security policy. Such a method is represented in FIG. 7 and is described later.

If the mitigation policy PGₖ detects an attack, a sending FE_1 of a signal to the user space USRₙ is performed. The instruction of this first sending FE_1 can be directly coded in the executable program of the mitigation policy.

This signal can for example take the form “Timestamp, IPHost, SecurityNamespaceID, CVEID, Msg”. Here, “Timestamp” corresponds to the millisecond when the mitigation policy was triggered in response to the attempt to exploit the vulnerability identified “CVEID”. “IPHost” corresponds to the IP address of the computer EQₙ. “SecurityNamespaceID” corresponds to the namespace dedicated to the security of container C1 on which the process p1 that triggered the policy was executed. “Msg” corresponds to an additional text message to describe the attack. An example of writing this signal could be: “1644824642, 192.168.1.152, 4026532216, CVE-2021-3156, Attempt to exploit CVE-XXXX-XXXX blocked”.

During step F_E2 of sending to the security management server Cnode, the module MDETₙ can optionally enrich the message described above with context information to more specifically characterize the attacked container (for example: name of the container image, name of the main process, start time of the container), to form the message Logᵢ.

The message Log sent during step F_E2 is received by the security management server CNode during step E_R.

During step E_A, a signal representative of this message Logᵢ is added to a list. This signal can for example be a copy of the message Logᵢ, or a compressed version of this message.

The example of the vulnerability CVE-2021-3156 makes it possible to illustrate the execution of a mitigation policy. This vulnerability CVE affecting the sudo command is particularly critical given that sudo is used in so many environments. When a command is passed with sudo, the arguments of the command are first concatenated and the metacharacters are escaped with an antislash (for example, “\” becomes “\\”). When a special character, for example [, {, (, \ or \hat{ }, is read as a regular character and not as a special character, it can be preceded by an antislash \. This is called escaping a character.

Particularly, the escape described here is not performed when sudo is executed via the symbolic link sudoedit-s. Therefore, if an argument of the sudoedit command ends with a single antislash, the arguments not being escaped by sudo, the program will copy characters outside the limits of the buffer, which will cause a buffer overflow.

A mitigation policy attached to the kernel function oper_exec( ) triggered by the launching of the execution of a binary can mitigate the vulnerability CVE-2021-3156 by detecting and blocking any attempt to execute the sudoedit command with an argument ending with a single antislash.

One example of an executable code snippet in eBPF (Extended Berkeley Packet Filter) language of such a mitigation policy is presented in the Annex 1. In this code snippet, the first call to the function STRING_HELPER verifies whether the command executed is sudoedit. The second call verifies whether an argument ends with a single antislash. If the sudoedit command is executed with a single antislash, then the execution of the command is canceled (with the instruction “RET_DENIED”), otherwise, the command is executed (with the instruction “RET_ALLOWED”).

In this example, the function STRING_HELPER is a support function necessary for the execution of the mitigation policy. It can in particular be loaded onto the kernel KERₙ as described later.

The Annex 2 presents an executable code snippet in eBPF language of a mitigation policy indicating a sending of a message to the user space if the sudoedit command was launched with a single antislash. This message indicates the detection of this attack by the mitigation policy. This code snippet can in particular be added to a line preceding the instruction “return RET_DENIED” in the code snippet presented by the Annex 1.

FIG. 2 represents a set composed of a security management server CNode, of two computers EQ₁ and EQ₂ and of a security server SRV_{SEC}.

The security management server CNode is equipped with a module MIDA implementing the identification method in accordance with one embodiment of the invention. It is also equipped with communication means 13′ with the computers and a module COM for communication with a user, for example an administrator of the set of computers.

Each computer EQ₁ and EQ₂ is equipped to implement the detection method in accordance with one embodiment of the invention. For the sake of clarity, the details of the computer EQ₂ are not detailed in FIG. 2, but it includes, like the computer EQ₁, the components making it possible to implement the computer attack detection method.

The computer EQ₁ includes a software system SYS₁ and hardware components, including in particular: a processor 10, a random access memory 11 of the RAM type, a read only memory 12 of the ROM type, communication means 13 and a non-volatile rewritable memory, for example a hard disk 14.

The communication means 13 are configured to communicate with the security server SRV_{SEC} and the security management server CNode.

The server SERV_{SEC} and the other means used in this example to implement the step of installing F_I a mitigation policy are presented below.

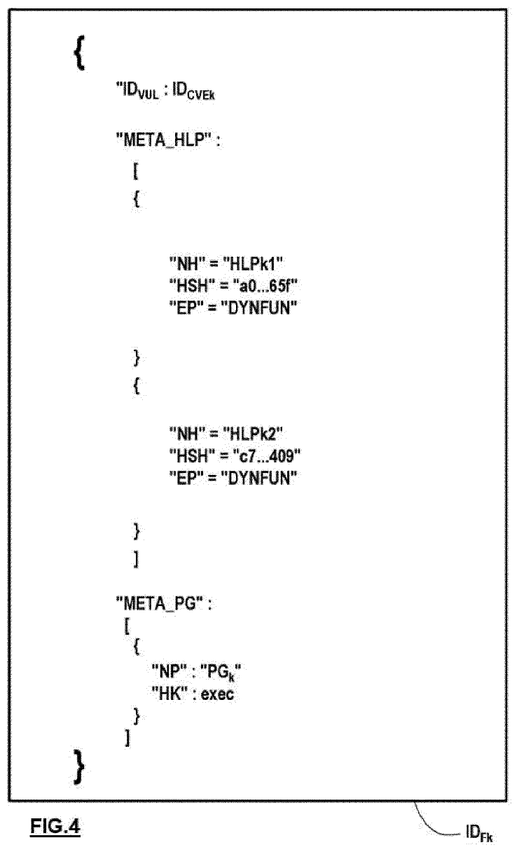

This security server SERV_{SEC} includes a database BD including a set of vulnerability identifiers CVE and in association with each of these vulnerability identifiers ID_{CVEi}, the identifier ID_{Fi} of a description file of a program PGᵢ configured to execute in the kernel of a computer and to implement a mitigation policy able to mitigate the identifier vulnerability ID_{CVEi}. The description file identified by ID_{Fi} is represented in FIG. 4 and is described later.

The programs PGᵢ can be downloaded by the equipment EQ₁ from the security server SERV_{SEC}. For the sake of simplicity, such a program PGᵢ implementing a mitigation policy is called mitigation policy.

A vulnerability identifier ID_{CVEi} is for example of the form CVE-AAAA-IIII, where AAAA is the year of publication and IIII a unique number.

In the embodiment described here, the mitigation policies PGᵢ downloadable from the security server SERV_{SEC} are source files in eBPF language, denoted PG^{S}ᵢ.

In another embodiment described here, the mitigation policies PGᵢ downloadable from the security server SERV_{SEC} are object files denoted PG^{O}ᵢ obtained by compilation of source files PG^{S}ᵢ in eBPF language.

In the embodiment described here, the description files are in JSON (Java Script Object Notation) format.

In the exemplary embodiment described here, the description file IDA of a mitigation policy PGᵢ includes:
in a field “ID_{VUL}”, the identifier ID_{CVEi} of the vulnerability that this policy can mitigate; and
in a structure “META_PG” of the metadata of the mitigation program PGᵢ.

In the embodiment described here, the metadata of the mitigation program PGᵢ include:
a metadata “NP” corresponding to the name of this program PG; and
at least one metadata “HK” corresponding to a trigger point (hook) of this program.

In the embodiment described here, a mitigation policy PGᵢ can make use of at least one support function (or dependency, “helper”) HLP_{i,j}.

In the exemplary embodiment described here, when a policy PGᵢ makes use of at least one support function HLP_{i,j}:
the description file IDA includes, in a structure “META_HLP”, metadata of this support function HLP_{i,j}; and
these support functions HLP_{i,j} can be downloaded from the security server SERV_{SEC}.

In the embodiment described here, the metadata META_HLP of a support function HLP_{i,j} include:
a metadata “NH” corresponding to the name of this support function;
a metadata “HSH” corresponding to a hash of this support function; and
a metadata “EP” corresponding to an entry point of the function.

The software system SYS₁ includes a kernel or operating system KER₁, and a user space USR₁. In the embodiment described here, the operating system KER₁ is of the Linux type (registered trademark).

In the embodiment represented in FIG. 2, the detection module MDET₁ includes an installation sub-module MINST₁. This submodule MINST₁ is configured to implement the installation step F_I of the detection method in accordance with the invention and whose main steps are represented in the form of a flowchart in FIG. 3.

In the example described here, the user space USR₁ includes:
a root process p0 and a container C1 associated with user-level rights created by the root process p0; and
an administration tool ADM₁ associated with administrator level rights.

In this example, the launching of the execution of a vulnerable function fc1 (for example sudoedit) causes the execution of the function exec in the user space USRₙ, itself launching the execution of the function oper_exec to be executed in the kernel KER₁.

The vulnerable function fc1 to be protected is for example the sudoedit function mentioned above.

A vulnerability CVE such as CVE-2021-3156 described previously can be detected at the level of the LSM (Linux Security Module) operations triggered by the launching of the execution of this function fc1. In this case, a central administrator can carry out the step of sending E_E a signal received by the kernel of each computer EQ₁ and EQ₂, or only to one of the two computers. As described previously, in this embodiment, this signal comprises an identifier of the vulnerability. This identifier makes it possible to implement the installation step F_I.

FIG. 3 represents one particular mode of implementation of the installation step F_I of the detection method. In this example, the installation F_I is implemented by an installation submodule MINSTₙ of the computer EQₙ.

This particular mode is described in the French patent application filed on Mar. 2, 2021 under number 2102026.

this installation step F_I for a computer EQₙ which can designate one of the computers EQ₁ and EQ₂ represented in FIG. 2 is described here.

During a sub-step F10 of the installation step F_I, the installation sub-module MINSTₙ sends a request REQ to the server SRV_{SEC}, this request REQ including the vulnerability identifier ID_{CVEK} corresponding to the signal sent E_E by the security management server and received (F_R) in the user space USRₙ of the computer EQₙ.

During a substep F20, the installation submodule MINSTₙ receives, in response to the request REQ, the description file whose identifier ID_{Fk} is associated with the vulnerability identifier ID_{CVEK} in the database BD of the security server SRV_{SEC}.

This description file ID_{Fk} is represented in FIG. 4.

In the exemplary embodiment described here, the description file ID_{Fk} includes:
in the field “ID_{VUL}”, the identifier ID_{CVEK} of the vulnerability;
in the structure “META_PG”, the metadata of a mitigation policy PGₖ of the vulnerability ID_{CVEK}; and
in the structure “META_HLP”, the metadata of two support functions HLPk1 and HLPk2 called by the policy PGₖ.

In the example of FIG. 4, the metadata META_PG of the mitigation program PGₖ include:
the metadata “NP” corresponding to the name PGₖ of this program; and
the metadata “HK” corresponding to the trigger point of the program PGₖ constituted here by the call of the function oper_exec, which corresponds for example to the execution of a binary.

In the example of FIG. 4, the metadata META_HLP of the support function HLPk1 include:
the metadata “NH” corresponding to the name HLPk1 of this support function;
the metadata “HSH” comprising a hash “a0 . . . 65f” of this support function; and
the metadata “EP” corresponding to an entry point DYNFUN in this support function, for example 4.

In the example of FIG. 4, the metadata META_HLP of the support function HLPk2 include:
the metadata “NH” corresponding to the name HLPk2 of this support function;
the metadata “HSH” comprising a hash “c7 . . . 409” of this support function; and
the metadata “EP” corresponding to an entry point DYNFUN in this support function; for example 2.

During a sub-step F30 of the installation step F_I, the installation sub-module MINSTₙ verifies whether the support functions HLPk1 and HLPk2 necessary for the execution of the mitigation policy PGₖ and identified in the description file ID_{Fk} received in substep F20 are already installed in the kernel KERₙ.

In the embodiment described here, the module MINSTₙ performs this verification through a kernel interface of the kernel KERₙ. This operation can be carried out by querying a virtual file system, for example similar to the system Sysfs described particularly in the Linux manual https://man7.org/linux/man-pages/man5/sysfs.5.html.

In practice, generic support functions likely to be called by many mitigation programs can be preinstalled in the kernel KERₙ.

In the exemplary embodiment described here, the support functions HLPk1 and HLPk2 are already installed in the kernel KERₙ and the result of the test F30 is positive.

During a substep F40, the installation module MINSTₙ downloads the mitigation program PGₖ identified in the description file ID_{Fk} received in substep F20. In the embodiment described here, this downloading is done from the security server SRV_{SEC}.

In the embodiment described here, this program (denoted PG^{S}ₖ) is downloaded in source code in the eBPF format.

During a substep F50, the installation module MINSTₙ compiles the mitigation program PGₖ.

During a substep F60, the mitigation program PGₖ is linked with a header file HDF according to a link editing mechanism (link), to obtain an executable mitigation program PG^{E}ₖ. In the embodiment described here, this header file HDF is stored in the rewritable non-volatile memory 14 (FIG. 2).

This header file HDF is updated every time a support function HLPk1 and HLPk2 is installed in the kernel KERₙ.

FIG. 8 illustrates one example of a header file HDF which can include, assuming that only the support functions HLPk1 and HLPk2 are installed in the kernel KERₙ and that the function HLPk1 was installed before the function HLPk2:
a first line L1 added when installing the support function HLPk1 in the kernel KERₙ; and
a second line L2 added when installing the support function HLPk2.

Each line L1, L2 can include:
the character string “#define_ID_”, concatenated
in the name of the support function, that is to say to the character string “HLPk1”, “HLPk2”, concatenated
to the character “______”, concatenated
to the hash of the support function, namely in this example “a0 . . . 65f” for the line L1 and “c7 . . . 409” for the line L2, concatenated
to the character string “______”, concatenated
to a number corresponding to a position index of the support function in the buffer of the kernel KERₙ, 0 for the line L1 and 1 for the line L2.

The header file HDF can include, after the set of lines L1, L2, . . . corresponding to each of the support functions installed in the kernel KERₙ, a line: #define fnsup_stat (fs_id, h, pe_id, arg) fnsup_dyn (__ID_##fs_id ##_##h ##_, pe_id, arg)

Those skilled in the art thus understand that if, for example, the mitigation file PGₖ includes in its source code the instruction fnsup_stat (HLPk1, a0 . . . 65f, 4, arg), the link editing substep F60 translates this instruction:
initially into fnsup_dyn (_ID_HLPk1_a0 . . . 65f_, 4, arg),
then secondly into fnsup_dyn (0, 4, arg), because, in line L1, _ID_HLPk1_a0 . . . 65f__is defined at 0 where 4 corresponds to the entry point to call in the support function HLPk1.

The executable form of the mitigation policy PGₖ, in binary, is stored in the non-volatile memory 14 of the computer EQₙ for installation in an area ZPS of the kernel KERₙ during a substep F70 described subsequently.

In the embodiment described here, the function fnsup_stat is a static function that acts as a proxy to call the support functions installed in the kernel KERₙ. In the embodiment described here, this function includes three parameters:
an identifier of the support function fs_id, valued at “0” in this example;
an entry point pe_id in the support function, valued at 4 in this example; and
arguments valued here at arg.

In accordance with this embodiment of the invention, when the mitigation programs are loaded into the kernel (substep F70 described later), a memory space is reserved for them, and the address of this memory space is associated with the support function identifier fs_id in a table TB of the kernel KERₙ.

In the example of FIG. 5 which illustrates a kernel KERₙ of a computer EQₙ, the table TB of the kernel KERₙ illustrates the situation in which the mitigation program PGₖ is installed at the address @PGₖ, with a support function identifier valued at 0 so that the execution of the instruction fnsup_dyn(0, 4, arg) triggers the execution of the mitigation policy PGₖ at the entry point 4, with the arguments arg.

Returning to the test F30 (FIG. 3), if it turns out that at least one support function HLPk1 and HLPk2 identified in the description file is not installed in the kernel KERₙ, the result of the test F30 is negative, and this support function must be downloaded (step H10) from the server SRV_{SEC} and installed (step H20) in the area ZPS of the kernel KERₙ represented in FIG. 5.

In the embodiment described here, the support functions are downloaded in object code and intended to be linked with the object code of the mitigation policy.

These download steps are carried out by a module of the user space USRₙ benefiting from administrator rights.

Once all the support functions necessary for the execution of the mitigation policy PGₖ are installed in the kernel KERₙ, this file can be compiled (sub-step F50), linked (sub-step F60) and loaded in turn in the kernel.

In the variant of embodiment described above, the mitigation program is downloaded in source code. As a variant, the mitigation program PGₖ is downloaded in the form of object code (denoted PG^{O}_{K}) and the compilation substep F50 is not necessary. In one embodiment of this variant, the compilation of the mitigation program into source code uses the description file IF_{Fk} of FIG. 4, and generates in addition to the object code PG^{O}_{K}, a table including a box for each support function called by this mitigation policy. The k^{th} box of this table is reserved to contain the identifier fs_id of the k^{th} support function taken in the order of the description file ID_{Fk}. This table is downloaded at the same time as the object code PG^{O}_{K}, during step F40. At the time of link editing (substep F60), each box k of the table is filled with the identifier HLP_{k,1} of the k^{th} support function.

It is important to remember that in this example, the mitigation policy PGₖ aims to mitigate and detect the vulnerability exploiting the call of the function fc1 by a process.

To execute the mitigation policy, and in the embodiment described here, the invention implements the security method described in the document [1].

This security method is represented in FIG. 7.

In the embodiment described here, the processes of the user space USRₙ are isolated using the namespace mechanism. For example, the operating system Linux proposes several namespaces (for example: Network, IPC, PID, User) that can be used to isolate processes in a mechanism in which sets of processes are defined, so that the processes of a given set cannot see the resources used by another set of processes.

In the example described here:
the root process p0 is associated respectively with different namespaces ENIPC0 (for IPC), ENIPD0 (for PID), ENUser0 (for User);
the processes of the container C1, in this case the process p1, are associated with different namespaces ENIPC1, ENIPD1, ENUser1.

In the example described here, the process p1 calls the function fc1 to be protected, the execution of which calls another function exec executing in the user space USRₙ.

In the embodiment described here, it is considered that the operations oper_open( ) of opening a file, oper_exec( ) of executing a function are sensitive operations.

In the example in FIG. 2, the process p1 of the container C1 calls:
the system call open( ) for opening a file which generates, when executed, the sensitive operation oper_open( ); and
the system call exec( ) for executing a binary which generates, when executed, the sensitive operation oper_exec( ).

In the example of FIG. 2, the process p0 does not call the functions exec( ) open( ).

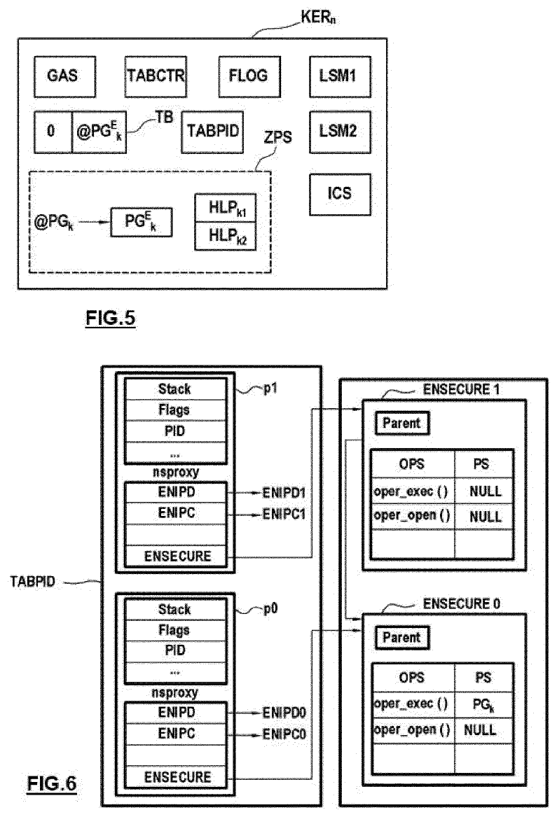

In accordance with the mechanism described in document [1] and represented in FIG. 6, the processes p0 and p1 are also associated with a namespace ENSECURE dedicated to security management.

In the embodiment described here, the process p0 is associated with the security management namespace ENSECURE0 and the container C1 is associated with the security management namespace ENSECURE1.

FIG. 6 represents a table TABPID of the processes stored in the kernel KERₙ. In the kernel KERₙ, a process is made up of a structure including several fields for managing its life cycle such as its identifier PID, its flags, its stack, and an nsproxy field which includes pointers to the namespaces.

Particularly, the field nsproxy includes a pointer ENSECURE to the namespace dedicated to security management associated with this process. This namespace defines a data structure which in particular comprises the mitigation policy.

The namespace ENSECURE of a process includes a link to the namespace ENSECURE of the parent of the namespace of this process. In the example described here, ENSECURE1 associated with the container C1 points to the namespace ENSECURE0 of the process p0.

The namespaces ENSECURE therefore form a tree.

In a manner known to those skilled in the art, a process can change the namespace to join the namespace of one of its child processes, for example by using the command unshare( ).

From the user space USRₙ, it is possible to access the identifier of a namespace but it is not possible to modify its structure. This characteristic advantageously makes it possible to prevent any modification or deactivation of a security or mitigation policy by a container.

In the exemplary embodiment described here, it is assumed that the process p0( ) has defined a mitigation policy PGₖ to secure the calls to the sensitive function execution operation oper_exec( ) It is assumed that it has not defined a security policy to secure the calls to the sensitive file opening operation oper_open( ).

In the exemplary embodiment described here, it is assumed that the container C1 has not defined its own security policy to secure the calls by its processes, in this case p1, to the sensitive binary execution operation oper_exec( ) in addition to the policy PGₖ defined by the process p0.

The context in which the mitigation policy PGₖ has been generated by compilation and editing of links during sub-steps F50 and F60 of the installation step F_I is now considered. The mitigation program PGₖ stored in the non-volatile memory 14 must be loaded into the security policy area ZPS of the kernel KERₙ.

In the embodiment of the installation step F_I described here, the installation submodule MINSTₙ includes instructions load_ps( ) to load (substep F70) a mitigation program in the form of an eBPF file compiled in binary form in the area ZPS of the kernel KERₙ. This function load_ps( ) consists in opening the eBPF file comprised in the non-volatile memory 14 and copying it to an interface with the kernel KERₙ. As described previously, this step comprises the allocation of a memory space in the area ZPS for this mitigation function, and the association of the address of this memory space with a support function identifier fs_id in a table TB of the kernel KERₙ.

In the embodiment described here, this writing in the kernel interface triggers an event to store the mitigation program in the namespace of the root process p0.

In the embodiment described here in relation to FIG. 5, the kernel KERₙ includes a security control infrastructure ICS for managing the Linux security modules, a Linux security management module LSM1 and possibly at least one other security module LSM2, for example, a SELinux module or an AppAmor module.

In the exemplary embodiment described here, the kernel KERₙ includes a control table TABCTR which defines, for each sensitive operation OPS (file opening, execution of a binary, etc.) whether the security module LSM1 wants to control or not these sensitive operations.

In the verification example described here, it is assumed that the security module LSM1 only wishes to verify the sensitive binary execution operation oper_exec( ).

FIG. 7 represents in flowchart form the main steps of a security method implemented by the system call manager GAS, the security control infrastructure ICS (LSM framework) and by the security module LSM1 as represented in FIG. 5.

In the exemplary embodiment described here, the system call manager GAS determines, during a step E10, whether a system call triggered by a process of the user space must perform a sensitive operation OPS. If so, it triggers the security control infrastructure ICS of the kernel KERₙ.

The framework ICS determines whether the sensitive operation OPS is listed in the table TABCTR.

In the exemplary embodiment described here, if a process wishes to carry out the sensitive file opening operation (oper_open( ) by call to the function open( ) as this sensitive operation is not verified by the security module LSM1, the result of the determination step is negative. This operation can nevertheless be verified by the security module LSM2, for example SELinux and an AppAmor module.

When the process p1 calls the function exec, the infrastructure ICS determines that this operation is listed in the table TABCTR and it triggers the execution of the security module LSM1 during a step E20.

During a step E30, the security module LSM1 determines the namespace associated with the current process at the origin of this call. To do so, it uses the current process from the table of the processes TABPID. This is the process p1.

The security module LSM1 then executes a loop to execute the policies of the namespace of the current process related to this sensitive operation. In one particular embodiment, the security module LSM1 then executes a loop to execute the policies of its ancestor namespaces if they exist.

During a step E40, the security module LSM1 determines whether the current namespace has defined one or several security policies to verify the validity of the sensitive operation.

This is the case if the binary execution function exec( ) was called by the process p1.

If this is the case, the concerned security module LSM1 executes during a step E50 the security policy(ies) defined in the namespace dedicated to the security management ENSECURE of the current process for this sensitive operation.

In this case, during the first iteration, no mitigation policy PGₖ is executed.

In the embodiment described here, a mitigation policy, and particularly the mitigation policy PGₖ returns a negative RET result if it detects a security problem (reflecting for example malicious or abnormal behavior) and a positive result if it does not detect any security issues.

If this RET value is positive, the security module determines, if it exists, the parent namespace of the namespace of the current process (step E60) and the loop repeats.

In this case, during the second iteration, the mitigation policy PGₖ of the namespace ENSECURE0 of the process p0 is executed and the function open_exec( ) is blocked.

The security module LSM1 records this blockage in a log file FLOG (FIG. 5) of the kernel KERₙ during a step E70 and sends a negative RET result to the security control infrastructure ICS. This log file FLOG can be analyzed by the administrator by means of the administration tool ADM.

In another case where all security policies (in this example only the mitigation policy PGₖ is installed) of the whole namespace tree have been executed with a positive RET result, the security module LSM1 sends a positive RET result to the security control infrastructure ICS (test E90).

In the embodiment described here, if the security control infrastructure ICS receives a positive RET result, it does not trigger a particular action and the system call is executed, unless an action is triggered by another security module LSM2, for example, a SELinux module or an AppAmor module.

In the embodiment described here, if the security control infrastructure ICS receives a negative RET result, the security control infrastructure ICS triggers a security action AS during a step E80. This action may consist in destroying the process at the origin of the call and raising an alert in the log file FLOG.
[1]: Snappy: Programmable Kernel-Level Policies for Containers, Maxime Bélair, Sylvie Laniepce, Jean-Marc Menaud, March 2021, ACM ISBN 978-1-4503-8104-8/21/03

The annexes are presented below.

```
  [Annex. 1]
  if (secuhub_helper(STRING_HELPER, HASH_STRING, STRING_
  BINNAME,
  {(void*)0, ″/usr/bin/sudo″}) == 1 &&
  secuhub_helper(STRING_HELPER, HASH_STRING, STRING_
  REGEX,
  {(void*)-1, ″\hat{ }( .*[\hat{ }\\])?\\$″}) == 1)
  return RET_DENIED;
return ALLOWED
  [Annex 2]
  secuhub_helper(STRING_HELPER, HASH_STRING, ALERT_ONCE,
{PR_ERR, ″Attempt to exploit CVE-2021-3156 blocked″});
```

1. A method for detecting an attempted computer attack implemented by a computer of a fleet of computers, said attack exploiting a vulnerability of a function to be protected executing in a process of a user space of said computer, a launching of the execution of said function to be protected resulting in the execution, before said attack, of a function of a kernel, said method including:
receiving, from a security management server, a mitigation policy identifier;
installing, in said kernel, a mitigation policy corresponding to said mitigation policy identifier;
executing said mitigation policy in said kernel, said mitigation policy being associated with said kernel function of said kernel and being loaded into a kernel namespace associated with said process and dedicated to security;
and, in response to detection by said mitigation policy during its execution of an attack vector supported by said policy and targeting said function to be protected:
sending to said security management server a message including a data representative of said process.

2. The method of claim 1, wherein the execution of said function to be protected leads to the execution of another function of said user space which leads to the execution of said function of the kernel.

3. The method of claim 1, wherein said mitigation policy is loaded into a namespace dedicated to security and associated with a root process of said computer.

4. The method of claim 1, wherein said security server is configured to send the mitigation policy identifier to a plurality of computers of said fleet of computers.

5. The method of claim 1, wherein said installation step includes sub-steps of:
sending a request including said mitigation policy identifier to a security server;
obtaining, in response to the request, a file describing said mitigation policy;
obtaining an object code of the mitigation policy identified in said description file;
generating an executable code of said mitigation policy from said object code; and
installing the executable code in said kernel.

6. The method of claim 1, wherein sending said at least one message to the security management server is implemented from said user space in response to said kernel sending a signal to said user space in order to notify said detection of said attack vector.

7. The method of claim 1, wherein said at least one message includes at least one piece of information among:
an identifier of said computer;
a data representative of said namespace associated with said process and dedicated to security;
an identifier of said vulnerability;
a time at which the execution of the mitigation policy has been triggered.

8. An identification method implemented by a security management server to identify an attempted computer attack on at least one computer of a fleet of computers, said attack exploiting a vulnerability of a function to be protected executing in a user space of the computer, said method including:
sending to said at least one computer an identifier of said mitigation policy;
receiving from said at least one computer, a message including a data representative of a process executing in said user space, when an attack vector targeting said function to be protected has been detected by the execution, in the kernel of the computer, of a mitigation policy loaded into a kernel namespace dedicated to security and associated with this process;
adding to a list a data representative of said message.

9. The method according to claim 8, further comprising sending, to a plurality of computers in the fleet of computers, said identifier of the mitigation policy.

10. A module for detecting an attempted computer attack in a computer of a fleet of computers, said attack exploiting a vulnerability of a function to be protected executing in a process of a user space of said computer, a launching of the execution of said function to be protected resulting in the execution, before said attack, of a kernel function, said module including:
a submodule for receiving, from a security management server, a mitigation policy identifier;
a submodule for installing, in said kernel, a mitigation policy corresponding to said mitigation policy identifier;
an execution submodule configured to execute said mitigation policy in said kernel, said mitigation policy being associated with said kernel function and being loaded into a namespace of the kernel associated with said process and dedicated to security;
a sending submodule configured to send, to said security management server, a message including a data representative of said process, said sending submodule being configured to send said message if said mitigation policy detects an attack vector supported by said policy and targeting said function to be protected.

11. An identification module which can be implemented by a security management server, said module being configured to identify an attempted computer attack on at least one computer of a fleet of computers, said attack exploiting a vulnerability of a function to be protected executing in a user space of said computer, said module including:
a submodule for sending to said at least one computer an identifier of said mitigation policy;
a receiving submodule configured to receive from said at least one computer, a message including a data representative of a process executing said user space, when an attack vector targeting the function to be protected has been detected, in the kernel of the computer, by the execution of a mitigation policy loaded into a namespace of the kernel dedicated to security and associated with the process;
an adding submodule configured to add to a list a data representative of said message.

12. A non-transitory computer readable medium having stored thereon instructions which, when executed by a processor, cause the processor to implement the method of claim 1.

13. (canceled)
